(19) United States
(12) Patent Application Publication
(10) Pub. No.: US 2008/0292748 A1
(43) Pub. Date: Nov. 27, 2008

(54) PROCESS FOR PRODUCTION OF AN EFFERVESCENT ALCOHOLIC BEVERAGE

(75) Inventors: Masahide SATO, Tokyo (JP); Atsushi Tanigawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SAPPORO BREWERIES LIMITED, Shibuya-ku (JP)

(21) Appl. No.: 12/126,495

(22) Filed: May 23, 2008

(30) Foreign Application Priority Data
May 25, 2007 (JP) P2007-139447

(51) Int. Cl. C12C 11/00; C12G 3/02

(52) U.S. Cl. 426/16; 426/11

(57) ABSTRACT

The present invention provides a process for production of an effervescent alcoholic beverage, the process comprising: a pH adjusting step in which the pH of a yeast-containing fermentate obtained by fermenting the raw material of an effervescent alcoholic beverage with the yeast is adjusted, and a storage step in which the fermentate is aged to yield an aged liquor. According to the present invention, it is possible to produce an effervescent alcoholic beverage which has a low hydrogen sulfide concentration and an excellent flavor without using gene recombination, while avoiding adverse effects on the main fermentation step.

### BACKGROUND OF THE INVENTION

1. Field of the Invention

The present invention relates to a process for production of an effervescent alcoholic beverage.

2. Related Background Art

Flavor is an important factor that determines the quality of effervescent alcoholic beverages brewed using yeast. Much research has been conducted with the main goal of developing, for example, beer, low-malt beer (happoshu), wine, sake and other brewages with flavors suited to consumer tastes.

Among factors that influence the flavor of effervescent alcoholic beverages, sulfur-containing compounds are well-known as a factor that negatively affect the flavor of effervescent alcoholic beverages brewed using yeast, and reduction of sulfur-containing compounds produced by yeast is considered to help improve the flavor and quality of effervescent alcoholic beverages.

Particularly in the case of low-malt beer brewed by fermenting low-nitrogen wort and effervescent alcoholic beverages brewed using pea, soybean or the like as a raw material instead of malt or barley, hydrogen sulfide, which causes sulfur odor, may remain in the final product, and its adverse effect on flavor and quality of the alcoholic beverage poses a major problem for product development.

Several measures for inhibiting production of sulfur-containing compounds by yeast have therefore been proposed. Examples of measures that have been proposed include: a method wherein an excess of hydrogen sulfide metabolites are added to the raw material solution during the main fermentation step, in which the yeast actively carries out alcohol fermentation, to cause feedback inhibition of hydrogen sulfide production; and a method wherein a brewer's yeast strain with low hydrogen sulfide production is selected for brewing.

In this regard, it has been reported that in the case of bottom-fermenting yeast used for beer brewing, increase of the methionine concentration or ammonium ion concentration in the wort during the main fermentation step causes feedback inhibition of hydrogen sulfide production (J. ASBC, 2004, Vol. 62, No. 1, p. 35-41).

Also, wine yeast strains for use in wine brewing which are resistant to sulfur-containing amino acid analogs (for example, ethionine, selenomethionine and S-ethylcysteine) have been reported as yeast strains with low hydrogen sulfide production (Japanese Patent Application Laid-Open No. 08-214869).

Gene recombination has also been used to create numerous yeast strains with low hydrogen sulfide production (Japanese Patent Application Laid-Open No. 05-192155; Japanese Patent Application Laid-Open No. 05-244955; Japanese Patent Application Laid-Open No. 2005-065572; Japanese Patent Application Laid-Open No. 07-303475).

### SUMMARY OF THE INVENTION

However, if sulfur-containing amino acid analogs are added to the raw material solution or the methionine concentration or ammonium ion concentration of the raw material solution is increased during the main fermentation step, in which the yeast actively carries out alcohol fermentation, this also poses problems, such as lowering of the fermentation rate and reduction of the amount of main flavor components.

Also, yeast strains created by gene recombination contain a promoter gene or drug resistance gene of different species that is not found in natural yeast. Therefore, from the viewpoint of safety, it has been difficult to use them in the brewing of effervescent alcoholic beverages and the like for human consumption.

It is an object of the present invention to provide: a process for producing an effervescent alcoholic beverage which has a low hydrogen sulfide concentration and an excellent flavor without using gene recombination, while avoiding adverse effects on the main fermentation step.

The present inventors found that the amount of hydrogen sulfide in an effervescent alcoholic beverage is negatively correlated with the pH of the fermentate in the storage step during which the fermentate is aged, and that by keeping the pH of the fermentate within a fixed range during the storage step, it is possible to obtain an effervescent alcoholic beverage having a low hydrogen sulfide concentration and an excellent flavor. The present invention was completed on the basis of this finding.

The present invention provides a process for production of an effervescent alcoholic beverage, the process comprising: a pH adjusting step in which the pH of a yeast-containing fermentate obtained by fermenting the raw material of an effervescent alcoholic beverage with the yeast is adjusted, and a storage step in which the fermentate is aged to yield an aged liquor.

Production steps for effervescent alcoholic beverages using yeast are generally divided into the following three steps: a mashing step in which a raw material mixture comprising the principal raw material (malt, barley, rice, pea, soybean, corn or the like) and water is warmed; a main fermentation step in which sugar (extract) in the raw material mixture (raw material solution) is decomposed into alcohol and carbon dioxide gas with yeast to accomplish alcohol fermentation; and a storage step in which the sugar (extract) remaining in the fermentate obtained from the main fermentation step is re-fermented at low temperature and the fermentate is aged. The main fermentation step and storage step have been carried out in series, and adjustment of the pH between these steps has not been performed.

However, if a pH adjusting step is carried out between the main fermentation step and storage step for adjustment of the pH of the yeast-containing fermentate after the main fermentation step as in the process of the invention, it is possible to reduce the hydrogen sulfide concentration of the final product (effervescent alcoholic beverage), and to improve the flavor of the effervescent alcoholic beverage.

Also, the process of the invention makes it possible to produce an effervescent alcoholic beverage while avoiding lowering of the fermentation rate and reduction of the amount of main flavor components. Also, the process of the invention, in which gene recombination does not need to be used, makes it possible to produce an effervescent alcoholic beverage that is safe for the human body. Also, the process of the invention, in which it is not necessary to breed a yeast using a yeast strain resistant to sulfur-containing amino acid analogs, makes it possible to control costs for development of effervescent alcoholic beverages.

As described above, the process of the invention makes it possible to produce an effervescent alcoholic beverage which has a reduced concentration of hydrogen sulfide and an improved flavor, compared to an effervescent alcoholic beverage produced without performing the pH adjusting step. Therefore, the process of the invention is also a process for production of an effervescent alcoholic beverage having an improved flavor, and a process for production of an effervescent alcoholic beverage having a reduced concentration of hydrogen sulfide.

The pH adjusting step is preferably a step in which the pH of the fermentate is adjusted so that the pH of the effervescent alcoholic beverage to be produced is 4.0 to 5.0, and more preferably so that the pH of the effervescent alcoholic beverage is 4.09 to 4.65.

If the pH of the effervescent alcoholic beverage is 4.0 to 5.0, the hydrogen sulfide concentration and sulfur odor of the beverage can be significantly reduced, and consumers will be able to drink the beverage almost without noticing any sulfur odor. Moreover, if the pH of the effervescent alcoholic beverage is 4.09 to 4.65, generation of stuffy smell or the like can be sufficiently prevented, and the flavor and quality of the beverage can be further improved.

The pH of the fermentate is preferably adjusted by adding calcium carbonate to the fermentate. Calcium carbonate is an acid neutralizer approved according to the current Japanese liquor tax law for use in the production of effervescent alcoholic beverages such as beer, and it can therefore be used as appropriate when carrying out the process of the invention.

The effervescent alcoholic beverage to be produced is preferably, for example, beer, low-malt beer, or an effervescent alcoholic beverage obtained using neither malt nor barley as a raw material. These effervescent alcoholic beverages are major effervescent alcohol beverages brewed using yeast, and they are suited to be produced by the process of the invention.

### BRIEF DESCRIPTION OF THE DRAWINGS

FIG. 1 is a graph showing the result of a simple linear regression analysis of the correlation between the pH and hydrogen sulfide concentration of 72 types of effervescent alcoholic beverages, which analysis was performed using hydrogen sulfide concentration as the response variable and pH as the explanatory variable.

FIG. 2 is a graph showing the time-dependent changes in suspended yeast count of raw material solution during the main fermentation step for 8 types of effervescent alcoholic beverages.

FIG. 3 is a graph showing the time-dependent changes in residual extract content of raw material solution during the main fermentation step for 8 types of effervescent alcoholic beverages.

FIG. 4 is a graph showing the hydrogen sulfide concentrations of 7 types of effervescent alcoholic beverages.

FIG. 5 is a graph showing the total points for sulfur odor for 7 types of effervescent alcoholic beverages.

FIG. 6 is a graph showing the number of votes for the changing point in flavor for 7 types of effervescent alcoholic beverages.

FIG. 7 is a graph showing the hydrogen sulfide concentrations of 5 types of effervescent alcoholic beverages.

FIG. 8 is a graph showing the hydrogen sulfide concentrations (mean±standard deviation) of 3 groups of effervescent alcoholic beverages.

### DESCRIPTION OF THE PREFERRED EMBODIMENTS

Preferred embodiments of the present invention will now be described in detail.

The process for production of an effervescent alcoholic beverage according to the invention is characterized by comprising: a pH adjusting step in which the pH of a yeast-containing fermentate obtained by fermenting the raw material of an effervescent alcoholic beverage with the yeast is adjusted, and a storage step in which the fermentate is aged to yield an aged liquor.

The term “effervescent alcoholic beverage” as used herein means an effervescent beverage that is obtained using yeast for alcohol fermentation of a grain (for example, malt, barley, rice or corn), legume (for example, pea or soybean) or the like as a raw material, and it may be, for example, beer, low-malt beer (happoshu), or an effervescent alcoholic beverage obtained using neither malt nor barley as a raw material. “Beer” is a fermented beverage obtained using malt, hop and water as the raw materials or using malt, hop, water, and barley or other commodities as established by the Japanese government ordinance (barley, rice, corn, kaoliang, potato, starch, saccharides, or bittering agents or coloring agents approved by the Department of the Treasury) as the raw materials, with the proportion of malt used being ⅔ or greater. “Low-malt beer (happoshu)” is an effervescent alcoholic beverage obtained using malt or barley as part of the raw materials, with the proportion of malt used being less than ⅔. An “effervescent alcoholic beverage obtained using neither malt nor barley as a raw material” is a beer-flavored effervescent alcoholic beverage brewed using pea, soybean, corn or the like as a raw material instead of malt or barley.

Ordinary processes for production of an effervescent alcoholic beverage using yeast generally comprise a mashing step, main fermentation step and storage step, and may optionally further comprise a filtration step in which the yeast and turbid substances are removed from the aged liquor obtained from the storage step. The process of the invention is characterized in that a new pH adjusting step is carried out between the main fermentation step and storage step for adjustment of the pH of the yeast-containing fermentate after the main fermentation step. When using the process of the invention, it is possible to produce an effervescent alcoholic beverage in the same manner as in conventional production processes for an effervescent alcoholic beverage using yeast, except that the pH adjusting step is carried out.

The “main fermentation step” in production of an effervescent alcoholic beverage is a step in which yeast is added to the raw material of the effervescent alcoholic beverage and a suitable temperature for fermentation of the yeast is maintained, allowing the yeast to decompose sugar (extract) in the raw material to accomplish alcohol fermentation. The “storage step” is a step in which the sugar (extract) remaining in the fermentate obtained from the main fermentation step is re-fermented at low temperature and the fermentate is aged, while the carbon dioxide gas is thoroughly dissolved to saturation in the fermentate.

The “fermentate” is a yeast-containing liquid obtained from the main fermentation step, which has not yet been aged in the storage step. The “aged liquor” is a liquid obtained by aging the fermentate for a prescribed period in the storage step, in which liquid the yeast and suspended matter in the fermentate is partly precipitated.

The process of the invention makes it possible to produce an effervescent alcoholic beverage which has a low hydrogen sulfide concentration and an excellent flavor. The “flavor” of an effervescent alcoholic beverage is, for example, aroma, mellowness (richness), acidity, sweetness, saltiness, bitterness, crispness and smoothness.

The flavor of an effervescent alcoholic beverage can be evaluated by performing an organoleptic evaluation test in which panelists taste the produced effervescent alcoholic beverage. Also, the flavor of an effervescent alcoholic beverage can be evaluated in numerical terms by analysis of factors that adversely affect the flavor, such as the hydrogen sulfide or diacetyl concentration.

Examples of fermentation conditions that affect the flavor of an effervescent alcoholic beverage include the yeast strain, medium, aeration rate of the medium, fermentation temperature and fermentation time. In the process of the invention, it is possible to adjust the pH of the yeast-containing fermentate after the main fermentation step without any particular change in such fermentation conditions, and to age the obtained fermentate in the storage step.

The pH adjusting step is a step between the main fermentation step and storage step in which the pH of the fermentate is artificially adjusted. The pH of the fermentate is preferably adjusted so that the pH of the effervescent alcoholic beverage to be produced is 4.0 to 5.0. The pH of the effervescent alcoholic beverage is more preferably 4.09 to 4.65, and even more preferably 4.30 to 4.65 (especially near 4.65).

In the pH adjusting step, an acid neutralizer that shifts the pH of the fermentate toward the alkaline side may be directly added to the fermentate. Examples of acid neutralizers include calcium carbonate, potassium carbonate, ammonia and sodium hydroxide, with calcium carbonate being preferred from the viewpoint of the Japanese liquor tax law.

The process of the invention may be applied for any effervescent alcoholic beverage that is produced using yeast. Preferred examples of effervescent alcoholic beverages that are produced using yeast include beer, low-malt beer, and effervescent alcoholic beverages obtained using neither malt nor barley as a raw material, and more preferred are low-malt beer brewed by fermenting low-nitrogen wort and effervescent alcoholic beverages obtained using neither malt nor barley as a raw material.

The present invention will now be explained in greater detail based on examples (experimental examples). However, the present invention is not limited to the examples described below.

### EXPERIMENTAL EXAMPLE 1

### Relationship Between Hydrogen Sulfide Concentration and pH of Effervescent Alcoholic Beverages

72 types of effervescent alcoholic beverages were produced in the following manner, and the relationship between the hydrogen sulfide concentration and pH of the effervescent alcoholic beverages was analyzed. The 72 types of effervescent alcoholic beverages were produced under the same conditions, except for differences in lots and production dates of the raw materials.

First, pea protein, saccharides and caramel color were dissolved in hot water at 80° C., and hops were then added and boiled therewith. After cooling, bottom-fermenting yeast (S. pastorianus) was added for fermentation at 12 to 15° C. for 5 to 7 days (main fermentation step). The obtained fermentate was transferred to a storage tank together with the yeast and allowed to stand at 10° C. for one week, after which it was further allowed to stand at 1° C. for 2 weeks for aging (storage step). The yeast and suspended matter were then filtered out (filtration step) to yield an effervescent alcoholic beverage. The conditions of the main fermentation step were as follows:

Extract concentration: about 11%;

Volume of raw material solution: 2.5 L;

Dissolved oxygen concentration of raw material solution: about 5 to 10 ppm;

Bottom-fermenting yeast input: 20 to 24 g of wet yeast cells.

With respect to the 72 types of effervescent alcoholic beverages, the pH of effervescent alcoholic beverage was measured at room temperature using a pH meter made by TOA Electronics Ltd. Also, the hydrogen sulfide concentration of effervescent alcoholic beverage was measured at room temperature using a 6890N gas chromatograph (Agilent Technologies). The detector used was a Sievers 355 (Agilent Technologies).

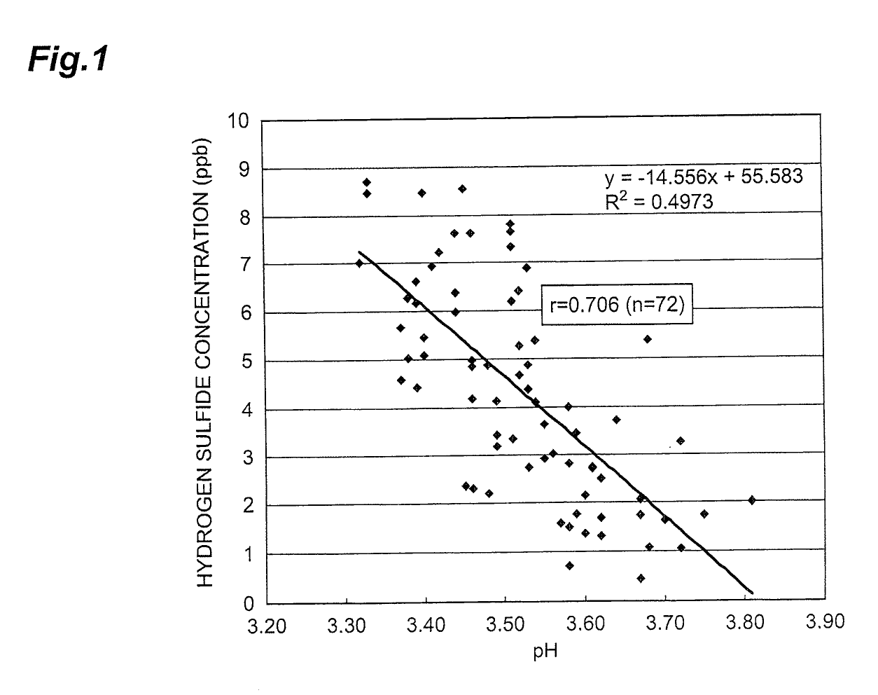

FIG. 1 is a graph showing the result of a simple linear regression analysis of the correlation between the pH and hydrogen sulfide concentration of the 72 types of effervescent alcoholic beverages, which analysis was performed using hydrogen sulfide concentration as the response variable and pH as the explanatory variable.

As seen in FIG. 1, a statistically significant negative correlation was found between pH and hydrogen sulfide concentration of the effervescent alcoholic beverages (r=0.706). The simple linear regression formula was:

[Hydrogen sulfide concentration (ppb) of effervescent alcoholic beverage]=−14.556×[pH of effervescent alcoholic beverage]+55.583

The results of Experimental Example 1 suggest that the amount of hydrogen sulfide in an effervescent alcoholic beverage produced using yeast is negatively correlated with the pH of the effervescent alcoholic beverage, and that production of an effervescent alcoholic beverage with a low hydrogen sulfide concentration requires the main fermentation step or storage step to be carried out in such a manner that the pH of the effervescent alcoholic beverage to be produced is high.

### EXPERIMENTAL EXAMPLE 2

### Adjustment of pH Before Main Fermentation Step

8 types of effervescent alcoholic beverages were produced in the following manner.

First, pea protein, saccharides and caramel color were dissolved in hot water at 80° C., and hops were then added and boiled therewith, after which the mixture was cooled to room temperature to yield 8 types of pre-fermentation raw material solutions. Potassium carbonate was added to seven of the pre-fermentation raw material solutions in amounts of 50, 100, 150, 175, 200, 250 and 300 ppm. Potassium carbonate was not added to the remaining pre-fermentation raw material solution.

Next, bottom-fermenting yeast (S. pastorianus) was added to each pre-fermentation raw material solution, and fermentation was carried out at 12 to 15° C. for 5 to 7 days (main fermentation step). The obtained fermentate was transferred to a storage tank together with the yeast and allowed to stand at 10° C. for one week, after which it was further allowed to stand at 1° C. for 2 weeks for aging (storage step). The yeast and suspended matter were then filtered out (filtration step) to yield an effervescent alcoholic beverage. The conditions of the main fermentation step were as follows:

Extract concentration: about 11%;

Volume of raw material solution: 2.5 L;

Dissolved oxygen concentration of raw material solution: about 5 to 10 ppm;

Bottom-fermenting yeast input: 20 to 24 g of wet yeast cells.

(Measurement of pH and Hydrogen Sulfide Concentration)

With respect to the 8 types of effervescent alcoholic beverages (control beverage 1 and test beverages 1 to 7), the pH of raw material solution and pH of effervescent alcoholic beverage were measured at room temperature using a pH meter made by TOA Electronics Ltd. Also, the hydrogen sulfide concentration of effervescent alcoholic beverage was measured at room temperature using a 6890N gas chromatograph (Agilent Technologies). The detector used was a Sievers 355 (Agilent Technologies).

Table 1 shows the pH of pre-fermentation raw material solution just after addition of potassium carbonate and the pH and hydrogen sulfide concentration of produced beverage for the 8 types of effervescent alcoholic beverages.

TABLE 1

| | | | | Hydrogen |
|---|---|---|---|---|
| | | | | sulfide |
| | | | | concentration |
| | Amount | pH of | pH of | (ppb) of |
| | (ppm) of | pre-fermentation | effervescent | effervescent |
| | potassium | raw material | alcohol | alcohol |
| | carbonate | solution | beverage | beverage |
| Control | 0 | 6.5 | 3.62 | 32.5 |
| beverage 1 | | | | |
| Test | 50 | 7.1 | 3.60 | 44.8 |
| beverage 1 | | | | |
| Test | 100 | 7.5 | 3.71 | 59.9 |
| beverage 2 | | | | |
| Test | 150 | 7.9 | 3.95 | 63.5 |
| beverage 3 | | | | |
| Test | 175 | 8.0 | 3.90 | 36.7 |
| beverage 4 | | | | |
| Test | 200 | 8.2 | 3.95 | 41.4 |
| beverage 5 | | | | |
| Test | 250 | 8.3 | 4.00 | 23.1 |
| beverage 6 | | | | |
| Test | 300 | 8.4 | 4.12 | 15.6 |
| beverage 7 | | | | |

As seen in Table 1, test beverages 6 and 7, which were obtained by performing the main fermentation step after addition of potassium carbonate in amounts of 250 and 300 ppm to the pre-fermentation raw material solution, had notably lower hydrogen sulfide concentrations than control beverage 1.

(Measurement of Suspended Yeast Count and Residual Extract Content)

With respect to the 8 types of effervescent alcoholic beverages, the changes in suspended yeast count and residual extract content of raw material solution during the main fermentation step was monitored, and the effect of the pH of pre-fermentation raw material solution on the progress of fermentation was analyzed.

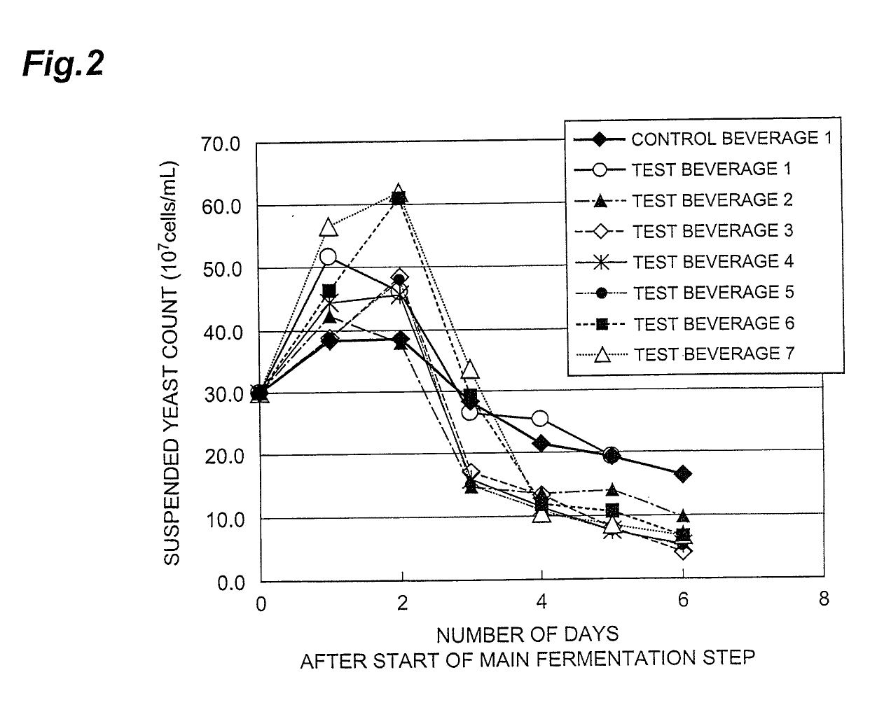

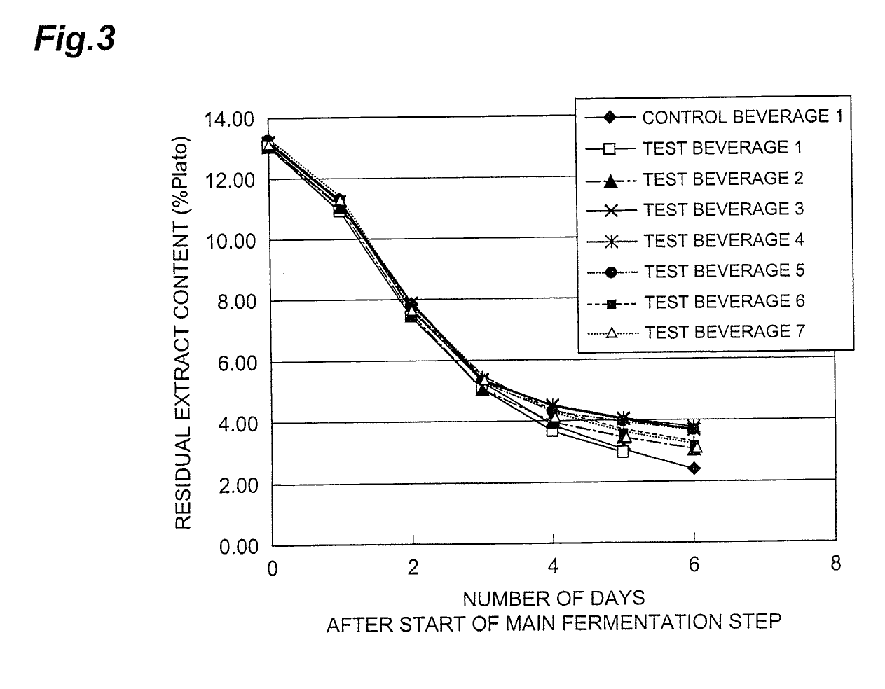

FIG. 2 is a graph showing the time-dependent changes in suspended yeast count of raw material solution during the main fermentation step for the 8 types of effervescent alcoholic beverages. FIG. 3 is a graph showing the time-dependent changes in residual extract content of raw material solution during the main fermentation step for the 8 types of effervescent alcoholic beverages.

As seen in FIGS. 2 and 3, test beverages 1 to 7 all had lower suspended yeast counts than control beverage 1, while the rate of decrease in extract content also tended to be inferior to that of the control beverage 1.

The results of Experimental Example 2 demonstrate that if the pH of the pre-fermentation raw material solution is adjusted prior to the main fermentation step, it is possible to reduce the hydrogen sulfide concentration of the effervescent alcoholic beverage by setting the pH of the pre-fermentation raw material solution at 8.3 or higher, but that this may cause adverse effects on the changes in suspended yeast count and extract content during the main fermentation step.

### EXPERIMENTAL EXAMPLE 3

### Adjustment of pH after Main Fermentation Step (Before Storage Step) Using Calcium Carbonate

7 types of effervescent alcoholic beverages were produced in the following manner.

First, pea protein, saccharides and caramel color were dissolved in hot water at 80° C., and hops were then added and boiled therewith. After cooling, bottom-fermenting yeast (S. pastorianus) was added for fermentation at 12 to 15° C. for 5 to 7 days (main fermentation step) to yield 7 types of fermentates. Calcium carbonate was added to six of the fermentates in amounts of 50, 100, 200, 250, 300 and 500 ppm. Calcium carbonate was not added to the remaining fermentate.

Next, each of the obtained fermentates was transferred to a storage tank together with the yeast and allowed to stand at 10° C. for one week, after which it was further allowed to stand at 1° C. for 2 weeks for aging (storage step). The yeast and suspended matter were then filtered out (filtration step) to yield an effervescent alcoholic beverage. The conditions of the main fermentation step were as follows:

Extract concentration: about 11%;

Volume of raw material solution: 2.5 L;

Dissolved oxygen concentration of raw material solution: about 5 to 10 ppm;

Bottom-fermenting yeast input: 20 to 24 g of wet yeast cells.

(Measurement of pH and Hydrogen Sulfide Concentration)

With respect to the 7 types of effervescent alcoholic beverages (control beverage 2 and test beverages 8 to 13), the pH of effervescent alcoholic beverage was measured at room temperature using a pH meter made by TOA Electronics Ltd. Also, the hydrogen sulfide concentration of effervescent alcoholic beverage was measured at room temperature using a 6890N gas chromatograph (Agilent Technologies). The detector used was a Sievers 355 (Agilent Technologies).

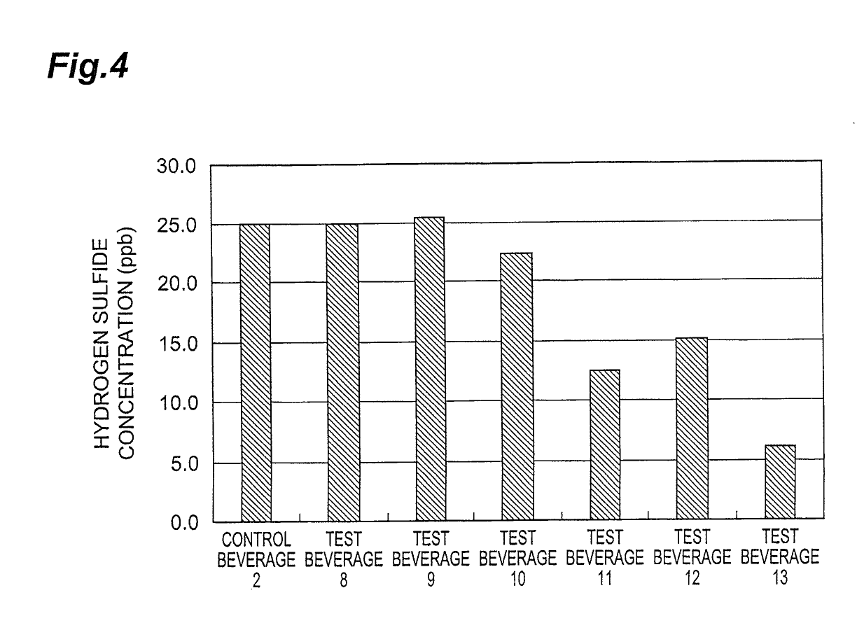

Table 2 shows the pH and hydrogen sulfide concentration of produced beverage for the 7 types of effervescent alcoholic beverages. FIG. 4 is a graph showing the hydrogen sulfide concentrations of the 7 types of effervescent alcoholic beverages.

TABLE 2

| | | | Hydrogen sulfide |
|---|---|---|---|
| | Amount | pH of | concentration |
| | (ppm) of | effervescent | (ppb) of |
| | calcium | alcohol | effervescent |
| | carbonate | beverage | alcohol beverage |
| Control beverage 2 | 0 | 3.61 | 24.8 |
| Test beverage 8 | 50 | 3.76 | 25.0 |
| Test beverage 9 | 100 | 4.06 | 25.4 |
| Test beverage 10 | 200 | 4.09 | 22.3 |
| Test beverage 11 | 250 | 4.65 | 12.4 |
| Test beverage 12 | 300 | 4.65 | 15.2 |
| Test beverage 13 | 500 | 4.99 | 6.1 |

As seen in Table 2 and FIG. 4, test beverages 10 to 13, which were obtained by adding calcium carbonate in amounts of 200 ppm or greater to the fermentate after the main fermentation step and then performing the storage step, had lower hydrogen sulfide concentrations than control beverage 2.

(Organoleptic Evaluation Test)

An organoleptic evaluation test regarding the sulfur odor strengths of the 7 types of effervescent alcoholic beverages was then performed. Specifically, ten adult panelists were asked to taste control beverage 2 and test beverages 8 to 13 blindly, and evaluation was made on a 4-level scale of 0 to 3, where 0 indicated no sulfur odor, 1 indicated weak sulfur odor, 2 indicated moderate sulfur odor and 3 indicated strong sulfur odor. The evaluation results were summed for each beverage, and the total values were used as the total points for sulfur odor.

Moreover, the ten adult panelists were asked to taste control beverage 2 and test beverages 8 to 13 one sip at a time in this order in a non-blind manner, and to vote for the beverage in which improvement in flavor was noticed. The numbers of votes for the changing point in flavor were summed for each beverage.

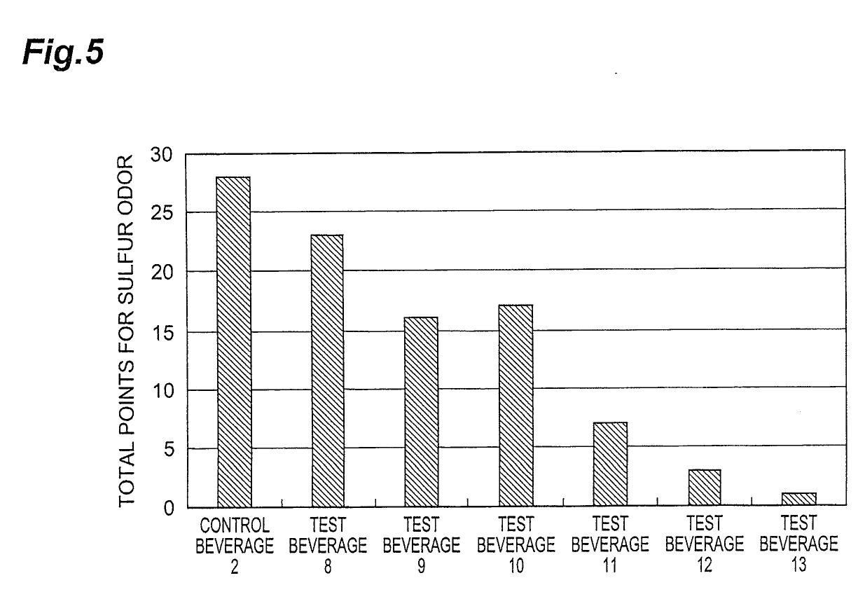

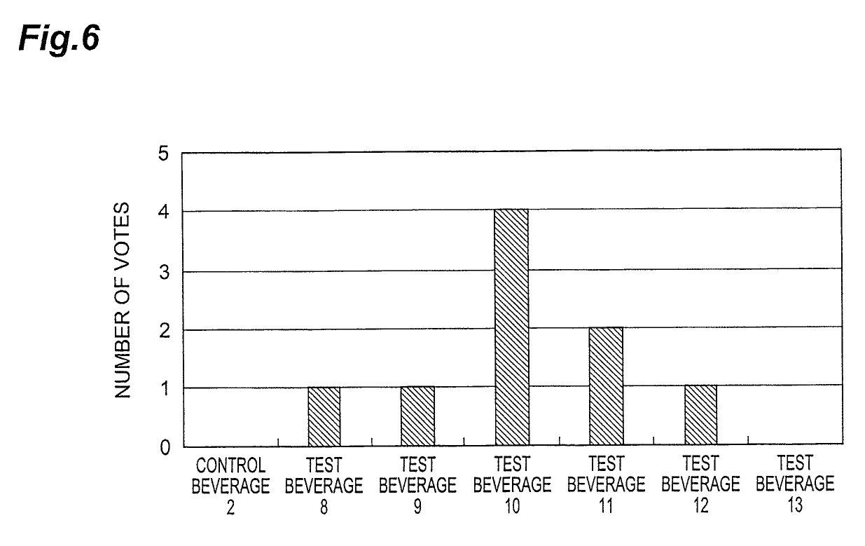

FIG. 5 is a graph showing the total points for sulfur odor for the 7 types of effervescent alcoholic beverages. FIG. 6 is a graph showing the number of votes for the changing point in flavor for the 7 types of effervescent alcoholic beverages.

As seen in FIG. 5, test beverages 9 to 13, which were obtained by adding calcium carbonate in amounts of 100 ppm or greater to the fermentate after the main fermentation step and then performing the storage step, had low total points for sulfur odor compared to control beverage 2. Test beverages 11 to 13, which were obtained by adding calcium carbonate in amounts of 250 ppm or greater before the storage step, had particularly low total points for sulfur odor. However, it was also found that excess addition of calcium carbonate that results in an excessively high pH of the effervescent alcoholic beverage can generate a stuffy smell.

As seen in FIG. 6, the beverage that the most panelists voted the changing point in flavor is test beverage 10, which was obtained by adding 200 ppm of calcium carbonate to the fermentate after the main fermentation step and then performing the storage step.

### EXPERIMENTAL EXAMPLE 4

### Adjustment of pH after Main Fermentation Step (Before Storage Step) Using Potassium Carbonate or Ammonia

5 types of effervescent alcoholic beverages were produced in the following manner.

First, pea protein, saccharides and caramel color were dissolved in hot water at 80° C., and hops were then added and boiled therewith. After cooling, bottom-fermenting yeast (S. pastorianus) was added for fermentation at 12 to 15° C. for 5 to 7 days (main fermentation step) to yield 5 types of fermentates. Potassium carbonate was added to three of the fermentates in amounts of 200, 320 and 368 ppm, and 800 μL of 25% ammonia was added to another of the fermentates. Neither potassium carbonate nor ammonia was added to the remaining fermentate.

Next, each of the obtained fermentates was transferred to a storage tank together with the yeast and allowed to stand at 10° C. for one week, after which it was further allowed to stand at 1° C. for 2 weeks for aging (storage step). The yeast and suspended matter were then filtered out (filtration step) to yield an effervescent alcoholic beverage. The conditions of the main fermentation step were as follows:

Extract concentration: about 11%;

Volume of raw material solution: 2.5 L;

Dissolved oxygen concentration of raw material solution: about 5 to 10 ppm;

Bottom-fermenting yeast input: 20 to 24 g of wet yeast cells.

(Measurement of pH and Hydrogen Sulfide Concentration)

With respect to the 5 types of effervescent alcoholic beverages (control beverage 3 and test beverages 14 to 17), the pH of effervescent alcoholic beverage was measured at room temperature using a pH meter made by TOA Electronics Ltd. Also, the hydrogen sulfide concentration of effervescent alcoholic beverage was measured at room temperature using a 6890N gas chromatograph (Agilent Technologies). The detector used was a Sievers 355 (Agilent Technologies).

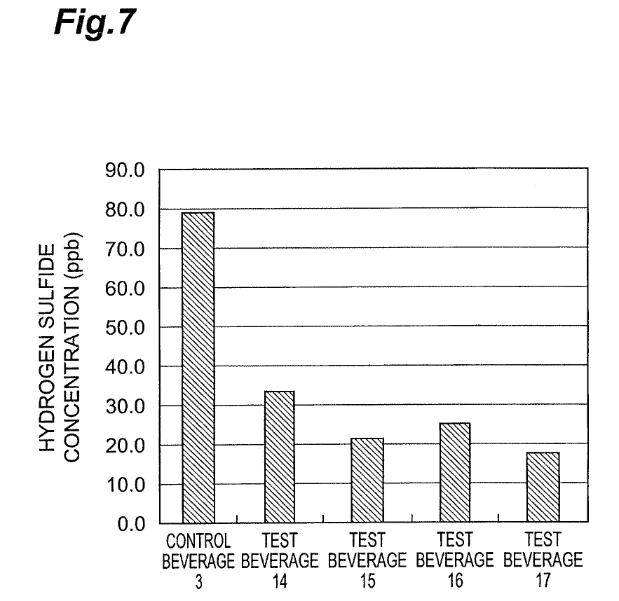

Table 3 shows the pH and hydrogen sulfide concentration of produced beverage for the 5 types of effervescent alcoholic beverages. FIG. 7 is a graph showing the hydrogen sulfide concentrations of the 5 types of effervescent alcoholic beverages.

TABLE 3

| | | | | Hydrogen |
|---|---|---|---|---|
| | | | | sulfide |
| | | | | concentration |
| | Amount | | pH of | (ppb) of |
| | (ppm) of | Amount | effervescent | effervescent |
| | potassium | (μL) of | alcohol | alcohol |
| | carbonate | 25% ammonia | beverage | beverage |
| Control | 0 | 0 | 3.64 | 79.0 |
| beverage 3 | | | | |
| Test | 200 | 0 | 4.07 | 33.4 |
| beverage 14 | | | | |
| Test | 320 | 0 | 4.32 | 21.3 |
| beverage 15 | | | | |
| Test | 368 | 0 | 4.42 | 25.1 |
| beverage 16 | | | | |
| Test | 0 | 800 | 4.36 | 17.8 |
| beverage 17 | | | | |

As seen in Table 3 and FIG. 7, test beverages 14 to 17, which were obtained by adding potassium carbonate or ammonia to the fermentate after the main fermentation step and then performing the storage step, had notably lower hydrogen sulfide concentrations than control beverage 3.

### EXPERIMENTAL EXAMPLE 5

### Adjustment of pH after Main Fermentation Step (Before Storage Step) Using Sodium Hydroxide

9 types of effervescent alcoholic beverages were produced in the following manner.

First, pea protein, saccharides and caramel color were dissolved in hot water at 80° C., and hops were then added and boiled therewith. After cooling, bottom-fermenting yeast (S. pastorianus) was added for fermentation at 12 to 15° C. for 5 to 7 days (main fermentation step) to yield 9 types of fermentates. 1M sodium hydroxide was added to three of the fermentates in an amount of 3 mL and to another three of the fermentates in an amount of 14 mL. Sodium hydroxide was not added to the remaining three fermentates.

Next, each of the obtained fermentates was transferred to a storage tank together with the yeast and allowed to stand at 10° C. for one week, after which it was further allowed to stand at 1° C. for 2 weeks for aging (storage step). The yeast and suspended matter were then filtered out (filtration step) to yield an effervescent alcoholic beverage. The conditions of the main fermentation step were as follows:

Extract concentration: about 11%;

Volume of raw material solution: 2.5 L;

Dissolved oxygen concentration of raw material solution: about 5 to 10 ppm;

Bottom-fermenting yeast input: 20 to 24 g of wet yeast cells.

(Measurement of pH and Hydrogen Sulfide Concentration)

With respect to the 9 types of effervescent alcoholic beverages [control group X (control beverages X1 to X3), test group A (test beverages A1 to A3) and test group B (test beverages B1 to B3)], the pH of effervescent alcoholic beverage was measured at room temperature using a pH meter made by TOA Electronics Ltd. Also, the hydrogen sulfide concentration of effervescent alcoholic beverage was measured at room temperature using a 6890N gas chromatograph (Agilent Technologies). The detector used was a Sievers 355 (Agilent Technologies).

Table 4 shows the pH and hydrogen sulfide concentration of produced beverage for the 9 types of effervescent alcoholic beverages. FIG. 7 is a graph showing the hydrogen sulfide concentrations (mean ±standard deviation) of the 3 groups of effervescent alcoholic beverages.

TABLE 4

| | | | | Hydrogen |
|---|---|---|---|---|
| | | | | sulfide |
| | | | | concentration |
| | | Amount | pH of | (ppb) of |
| | | (mL) of 1M | effervescent | effervescent |
| | | sodium | alcohol | alcohol |
| | | hydroxide | beverage | beverage |
| Control | Control | 0 | 3.7 | 52 |
| group X | beverage X1 | | | |
| | Control | 0 | 3.7 | 75 |
| | beverage X2 | | | |
| | Control | 0 | 3.7 | 54 |
| | beverage X3 | | | |
| Test group A | Test | 3 | 4.0 | 47 |
| | beverage A1 | | | |
| | Test | 3 | 4.1 | 21 |
| | beverage A2 | | | |
| | Test | 3 | 4.0 | 22 |
| | beverage A3 | | | |
| Test group B | Test | 14 | 5.0 | 2 |
| | beverage B1 | | | |
| | Test | 14 | 5.1 | 6 |
| | beverage B2 | | | |
| | Test | 14 | 5.0 | 4 |
| | beverage B3 | | | |

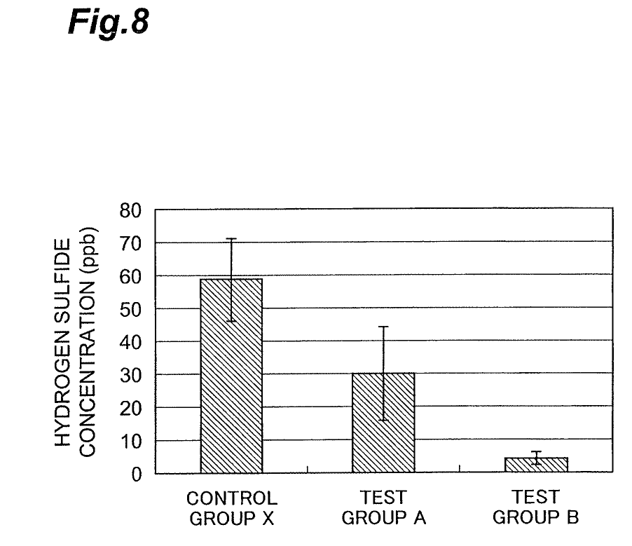

As seen in Table 4 and FIG. 8, test beverages A1 to A3 and B1 to B3, which were obtained by adding sodium hydroxide to the fermentate after the main fermentation step and then performing the storage step, had notably lower hydrogen sulfide concentrations than control beverages X1 to X3.

The results of Experimental Examples 1 to 5 demonstrate that if the pH of the yeast-containing fermentate is adjusted after the main fermentation step and the storage step is performed, it is possible to reduce the hydrogen sulfide concentration of the effervescent alcoholic beverage, and to improve the flavor of the effervescent alcoholic beverage.

According to the present invention, it is possible to produce an effervescent alcoholic beverage which has a low hydrogen sulfide concentration and an excellent flavor without using gene recombination, while avoiding adverse effects on the main fermentation step.

What is claimed is:

1. A process for production of an effervescent alcoholic beverage, the process comprising:
a pH adjusting step in which the pH of a yeast-containing fermentate obtained by fermenting the raw material of an effervescent alcoholic beverage with the yeast is adjusted, and
a storage step in which the fermentate is aged to yield an aged liquor.

2. A process for production of an effervescent alcoholic beverage having an improved flavor, the process comprising:
a pH adjusting step in which the pH of a yeast-containing fermentate obtained by fermenting the raw material of an effervescent alcoholic beverage with the yeast is adjusted, and
a storage step in which the fermentate is aged to yield an aged liquor.

3. A process for production of an effervescent alcoholic beverage having a reduced concentration of hydrogen sulfide, the process comprising:
a pH adjusting step in which the pH of a yeast-containing fermentate obtained by fermenting the raw material of an effervescent alcoholic beverage with the yeast is adjusted, and
a storage step in which the fermentate is aged to yield an aged liquor.

4. The process according to claim 1, wherein the pH adjusting step is a step in which the pH of the fermentate is adjusted so that the pH of the effervescent alcoholic beverage to be produced is 4.0 to 5.0.

5. The process according to claim 2, wherein the pH adjusting step is a step in which the pH of the fermentate is adjusted so that the pH of the effervescent alcoholic beverage to be produced is 4.0 to 5.0.

6. The process according to claim 3, wherein the pH adjusting step is a step in which the pH of the fermentate is adjusted so that the pH of the effervescent alcoholic beverage to be produced is 4.0 to 5.0.

7. The process according to claim 1, wherein the pH of the fermentate is adjusted by adding calcium carbonate to the fermentate.

8. The process according to claim 2, wherein the pH of the fermentate is adjusted by adding calcium carbonate to the fermentate.

9. The process according to claim 3, wherein the pH of the fermentate is adjusted by adding calcium carbonate to the fermentate.

10. The process according to claim 4, wherein the pH of the fermentate is adjusted by adding calcium carbonate to the fermentate.

11. The process according to claim 5, wherein the pH of the fermentate is adjusted by adding calcium carbonate to the fermentate.

12. The process according to claim 6, wherein the pH of the fermentate is adjusted by adding calcium carbonate to the fermentate.

13. The process according to claim 1, wherein the effervescent alcoholic beverage to be produced is beer, low-malt beer, or an effervescent alcoholic beverage obtained using neither malt nor barley as a raw material.

14. The process according to claim 2, wherein the effervescent alcoholic beverage to be produced is beer, low-malt beer, or an effervescent alcoholic beverage obtained using neither malt nor barley as a raw material.

15. The process according to claim 3, wherein the effervescent alcoholic beverage to be produced is beer, low-malt beer, or an effervescent alcoholic beverage obtained using neither malt nor barley as a raw material.

16. The process according to claim 4, wherein the effervescent alcoholic beverage to be produced is beer, low-malt beer, or an effervescent alcoholic beverage obtained using neither malt nor barley as a raw material.

17. The process according to claim 5, wherein the effervescent alcoholic beverage to be produced is beer, low-malt beer, or an effervescent alcoholic beverage obtained using neither malt nor barley as a raw material.

18. The process according to claim 6, wherein the effervescent alcoholic beverage to be produced is beer, low-malt beer, or an effervescent alcoholic beverage obtained using neither malt nor barley as a raw material.
